(19) United States
(12) Patent Application Publication
(10) Pub. No.: US 2024/0419160 A1
(43) Pub. Date: Dec. 19, 2024

(54) Analyzing a target system

(71) Applicant: Elisa Oyj, Helsinki (FI)

(72) Inventors: Viivi UURTIO, Helsinki (FI); Antti LISKI, Helsinki (FI)

(21) Appl. No.: 18/702,834

(22) PCT Filed: Nov. 15, 2022
(86) PCT No.: PCT/FI2022/050748

§ 371 Date: Apr. 19, 2024

(30) Foreign Application Priority Data
Nov. 16, 2021 (FI) 20216172

(51) Int. Cl. G05B 23/02

(52) U.S. Cl. CPC G05B 23/024; G05B 23/0294; G05B 2223/06

(57) ABSTRACT

A computer implemented method for analyzing a target system for the purpose of controlling the target system. The method is performed by obtaining (301) a dataset comprising observations related to the target system; computing (302) alignment score for the dataset using a linear kernel to obtain a linear alignment score; computing (302) alignment score for the dataset using a non-linear kernel to obtain a non-linear alignment score; comparing (303) the linear alignment score and the non-linear alignment score; and if linear alignment score>non-linear alignment score, selecting (304) anomaly detection that uses Euclidean space measures, and else selecting anomaly detection that uses non-Euclidean space measures.

### TECHNICAL FIELD

The present disclosure generally relates to analyzing a target system. The disclosure relates particularly, though not exclusively, to analyzing the target system for the purpose of controlling the target system.

### BACKGROUND

This section illustrates useful background information without admission of any technique described herein representative of the state of the art.

There are various automated measures that monitor and analyze operation of complex target systems, such as mobile communication networks or industrial processes, in order to detect problems so that corrective actions can be taken.

For example, anomaly detection models may be used for analyzing observations from a target system (e.g. measurement results) to identify anomalies or data points that stand out from the rest of the data. Anomaly detection refers to identification of data points, items, observations, events, or other variables that do not conform to an expected pattern of a given data sample or data vector. Anomaly detection models can be trained to learn the structure of normal data samples. The models output an anomaly score for an analysed sample, and the sample is classified as an anomaly, if the anomaly score exceeds some predefined threshold. Such models include for example k nearest neighbors (kNN), local outlier factor (LOF), principal component analysis (PCA), kernel principal component analysis, independent component analysis (ICA), isolation forest, autoencoder, angle-based outlier detection (ABOD), and others. Different models represent different hypotheses about how anomalous points stand out from the rest of the data.

Anomaly detection methods measure the degree of anomalousness in either a Euclidean or a non-Euclidean space. In a Euclidean space, the observations are analysed without additional transformations, meaning that the original measured values of an observation are applied to decide whether the observation is an anomaly or not. In a non-Euclidean space, the observations are transformed such that the similarities, or dissimilarities, are enhanced.

For the purpose of anomaly detection and especially for detecting relevant anomalies from an unlabelled dataset, there is a need to know, in which space, a Euclidean or a non-Euclidean, these anomalies are best characterized. In this way, appropriate measures can be applied for capturing the anomalies.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a computer implemented method for analyzing a target system for the purpose of controlling the target system. In an example embodiment, the method comprises obtaining a dataset comprising observations related to the target system;
computing alignment score for the dataset using a linear kernel to obtain a linear alignment score;
computing alignment score for the dataset using a non-linear kernel to obtain a non-linear alignment score;
comparing the linear alignment score and the non-linear alignment score;
if linear alignment score>non-linear alignment score, selecting anomaly detection that uses Euclidean space measures, and else selecting anomaly detection that uses non-Euclidean space measures.

In some embodiments, the non-linear kernel is a radial kernel or a polynomial kernel.

In some embodiments, the dataset comprises unlabelled observations related to the target system.

In some embodiments, a centred kernel target alignment method is applied for computing the alignment scores.

In some embodiments, the alignment scores are computed by maximizing alignment score relative to initially unknown label-vector. In some embodiments, the maximization of the alignment score is formulated as an optimization problem with respect to a target vector. In some embodiments, the maximization of the alignment score is performed using a process that iteratively updates the target vector until objective converges and that returns the target vector and the alignment score.

In some embodiments, non-Euclidean space measures comprise one or more of robust principal component analysis, kernel principal component analysis and neural network-based methods.

In some embodiments, Euclidean space measures comprise one or more of principal component analysis, isolation forest and local outlier factor.

In some embodiments, the target system is a mobile communication network, and the observations relate to network performance.

In some embodiments, the target system is an industrial process, and the observations comprise sensor data from the industrial process.

In some embodiments, the target system is a life science application, and the observations comprise measurement results.

In some embodiments, the method further comprises performing the selected anomaly detection. Still further, the method may comprise using results from the anomaly detection for controlling the target system.

According to a second example aspect of the present invention, there is provided an apparatus comprising a processor and a memory including computer program code; the memory and the computer program code configured to, with the processor, cause the apparatus to perform the method of the first aspect or any related embodiment.

According to a third example aspect of the present invention, there is provided a computer program comprising computer executable program code which when executed by a processor causes an apparatus to perform the method of the first aspect or any related embodiment.

According to a fourth example aspect there is provided a computer program product comprising a non-transitory computer readable medium having the computer program of the third example aspect stored thereon.

According to a fourth example aspect there is provided an apparatus comprising means for performing the method of any preceding aspect.

Any foregoing memory medium may comprise a digital data storage such as a data disc or diskette; optical storage; magnetic storage; holographic storage; opto-magnetic storage;

phase-change memory; resistive random-access memory; magnetic random-access memory; solid-electrolyte memory; ferroelectric random-access memory; organic memory;

or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIG. 2 shows a block diagram of an apparatus according to an example embodiment; and

FIG. 3 shows a flow chart according to an example embodiment; and

FIG. 4 shows dataset of an example case.

### DETAILED DESCRIPTION

In the following description, like reference signs denote like elements or steps.

A challenge in analyzing observations related to complex target systems, such as mobile communication networks, life science applications and industrial processes, is that the amount of data is huge and therefore automated analysis is needed. For example, when starting to mine for anomalies from an unlabelled dataset it is generally challenging to decide from which space (Euclidean or non-Euclidean) will the anomalies be best uncovered.

Various embodiments of present disclosure provide mechanisms to analyse observations so that it can be automatically decided whether the observations are better suited for anomaly detection analysis in a Euclidean or in a non-Euclidean space. Various embodiments output a score or scores that can be used for deciding which space will best characterize anomalies of the dataset that is being analyzed. The starting point may be an unlabelled dataset of observations.

In the context of present disclosure, the observations that are analysed may comprise measurement results or other data obtained from the target system. The observations may involve, for example, data that represents network performance of a mobile communication network. In such case, the observations may include for example network probe data or performance data such as key performance indicator values, signal level, throughput, number of users, number of dropped connections, number of dropped calls etc.

Life science applications in which present embodiments may be applied include for example healthcare or biological applications. In such case, the observations may be described by variables that represent measurements from an organism, and the analysis of presently disclosed embodiments may facilitate the detection of anomalous observations.

In yet other alternatives, the observations may involve sensor data such as pressure, temperature, manufacturing time, electric measurements, yield of a production phase etc. of an industrial process. Still further, the observations may involve data related to asset performance optimization.

Various embodiments of present disclosure solve the technical problem of how to select which anomaly detection method to use for controlling a target system, the target system being a mobile communication network, an industrial process, a life science application, or an asset performance optimization system. The selected anomaly detection method may then be used for detecting problems in the target system and for performing appropriate corrective actions.

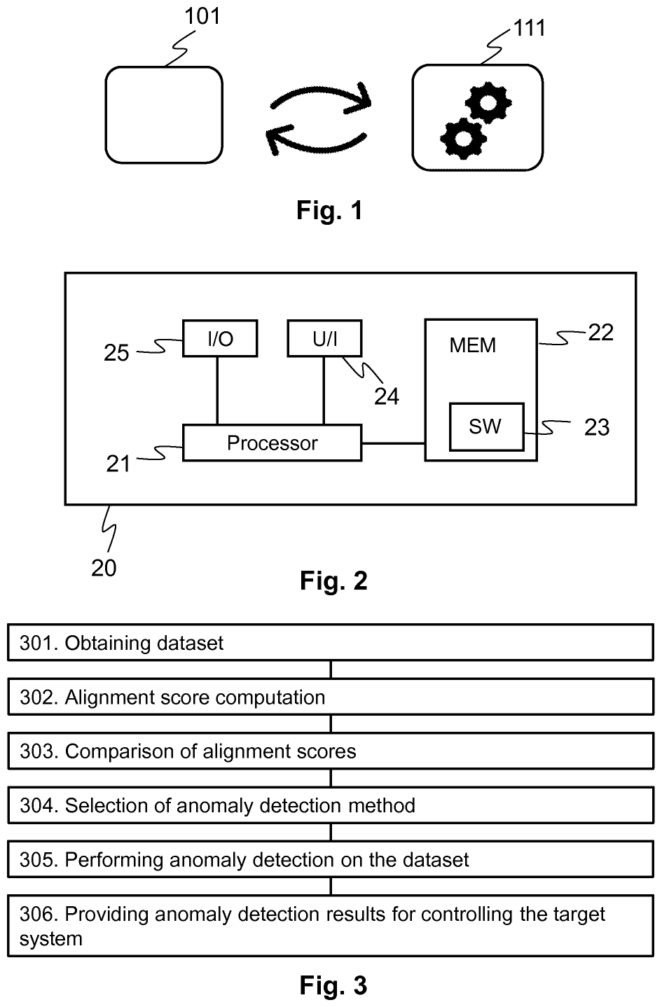

FIG. 1 schematically shows a system according to an example embodiment. The system shows a controllable target system 101 and an automation system 111 configured to implement analysis of the target system according to example embodiments.

The target system 101 may be for example a mobile communication network, comprising a plurality of physical network sites comprising base stations and other network devices. Alternatively, the target system 101 may be a life science application, an industrial process, an asset performance optimization system, or some other complex target system. The automation system 111 is configured to implement at least some example embodiments of present disclosure.

In an embodiment the system of FIG. 1 operates as follows: the automation system 111 obtains dataset of observations directly from the target system 101 or through some intermediary system. The automation system 111 then analyses the dataset to decide whether to perform anomaly detection in a Euclidean space or in a non-Euclidean space, i.e. to decide what type of anomaly detection methods are most appropriate for uncovering anomalies in the dataset, that is, whether to use anomaly detection methods that transform the data or anomaly detection methods that do not apply transformations.

The output of the automation system 111 facilitates the selection of most suitable anomaly detection method or methods, that is, the set of potential methods is reduced. The set of methods selected based on the output of the automation system 111 may generate more similar and hence reliable detection results. That is, the anomaly detection may then be applied in accordance with the output of the automation system 111. Further, the results of the anomaly detection may be used for controlling the target system 101. Additionally or alternatively, the anomaly detection results may be displayed to a user, stored for later use, and/or provided for further analysis.

The process in the automation system 111 may be manually or automatically triggered. Additionally or alternatively, the process may be periodically repeated.

FIG. 2 shows a block diagram of an apparatus 20 according to an embodiment. The apparatus 20 is for example a general-purpose computer, cloud computing environment or some other electronic data processing apparatus. The apparatus 20 can be used for implementing at least some embodiments of the invention. That is, with suitable configuration the apparatus 20 is suited for operating for example as the automation system 111 of FIG. 1.

The apparatus 20 comprises a communication interface 25; a processor 21; a user interface 24; and a memory 22. The apparatus 20 further comprises software 23 stored in the memory 22 and operable to be loaded into and executed in the processor 21. The software 23 may comprise one or more software modules and can be in the form of a computer program product.

The processor 21 may comprise a central processing unit (CPU), a microprocessor, a digital signal processor (DSP), a graphics processing unit, or the like. FIG. 2 shows one processor 21, but the apparatus 20 may comprise a plurality of processors.

The user interface 24 is configured for providing interaction with a user of the apparatus. Additionally or alternatively, the user interaction may be implemented through the communication interface 25. The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 may comprise for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories. The memory 22 may serve the sole purpose of storing data, or be constructed as a part of an apparatus 20 serving other purposes, such as processing data.

The communication interface 25 may comprise communication modules that implement data transmission to and from the apparatus 20. The communication modules may comprise a wireless or a wired interface module(s) or both. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. The communication interface 25 may support one or more different communication technologies. The apparatus 20 may additionally or alternatively comprise more than one of the communication interfaces 25.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like.

FIG. 3 shows a flow chart according to an example embodiment. FIG. 3 illustrates a process comprising various possible steps including some optional steps while also further steps can be included and/or some of the steps can be performed more than once. The process may be implemented in the automation system of FIG. 1 and/or in the apparatus 20 of FIG. 2. The process is implemented in a computer program code and does not require human interaction unless otherwise expressly stated. It is to be noted that the process may however provide output that may be further processed by humans and/or the process may require user input to start.

The process of FIG. 3 comprises the following steps:
301: Dataset is obtained. The dataset comprises observations related to a target system that is being analysed. In an embodiment, the dataset comprises unlabelled observations related to the target system.

In an embodiment, the target system is a mobile communication network, and the observations relate to network performance. In another embodiment, the target system is an industrial process, and the observations comprise sensor data from the industrial process. In yet another embodiment, the target system is a life science application, and the observations comprise measurement results.

302: Alignment score computation. Linear and non-linear alignment scores are computed for the dataset. The linear alignment score is computed using a linear kernel. The non-linear alignment score is computed using a non-linear kernel. In an embodiment, the non-linear kernel is a radial kernel or a polynomial kernel.

In an embodiment, centred kernel target alignment method is applied for obtaining the alignment scores.

In an embodiment, the alignment scores are computed by maximizing alignment score relative to initially unknown label-vector.

In an example embodiment, the linear alignment score ρₗᵢₙₑₐᵣ and the non-linear alignment score ρₙₒₙ₋ₗᵢₙₑₐᵣ are calculated using equations:

$${ρ}_{linear} = {max}_{y} \frac{trace ( {K}_{linear} {K}_{linear} ( y , y ) )}{{‖ {K}_{linear} ‖}_{F} {‖ {K}_{linear} ( y , y ) ‖}_{F}}$$

$${ρ}_{non - linear} = {max}_{y} \frac{trace ( {K}_{non - linear} {K}_{non - linear} ( y , y ) )}{{‖ {K}_{non - linear} ‖}_{F} {‖ {K}_{non - linear} ( y , y ) ‖}_{F}}$$

In an example embodiment, input for the centred kernel target alignment method is X(centred data matrix), τ(momentum hyperparameter), and the method outputs ρ(alignment score), γ(target label vector).

The centred kernel target alignment method comprises the following steps:

| | |
|---|---|
| 1: Kₓ ← k(x, x) | [symbol] compute kernel, centre |
| 2: y ~ U(−1, 1), K_{y} ← k(y, y) | [symbol] initialise y, compute kernel, centre |
| 3: Repeat steps 4-7 | |
| 4: fₜ = ρ(Kₓ, K_{y}) | [symbol] evaluate objective |
| $5 : {∇}_{y} = \frac{δρ ( {K}_{x} , {K}_{y} )}{δ y}$ | [symbol] evaluate gradient |
| 6: yₜ₊₁ = yₜ + η∇_{y} + τ_{y-1} | [symbol] update y, step size η determined by |
| | line search |
| 7: fₜ₊₁ = ρ(Kₓ, K_{y}^{t+1}) | [symbol] update objective |
| 8: Until \|fₜ-fₜ₊₁\|/\|fₜ + fₜ₊₁ | [symbol] stop at convergence |

9: Return y_{final} = yₜ₊₁, ρ_{final} = fₜ₊₁

303: Comparison of alignment scores. It is determined which one of the linear alignment score ρₗᵢₙₑₐᵣ and the non-linear alignment score ρₙₒₙ₋ₗᵢₙₑₐᵣ is higher.

304: Selection of anomaly detection methods.

Anomaly detection using Euclidean space measures is selected if ρₗᵢₙₑₐᵣ>ρₙₒₙ₋ₗᵢₙₑₐᵣ (i.e. linear alignment score is higher than non-linear alignment score). That is, anomaly detection methods that do not transform the observations of the dataset will be selected as means for detecting anomalies. Anomaly detection using non-Euclidean space measures if ρₙₒₙ₋ₗᵢₙₑₐᵣ>ρₗᵢₙₑₐᵣ (i.e. non-linear alignment score is higher than linear alignment score). That is, anomaly detection methods that apply transformations on the observations of the dataset will be selected as means for detecting anomalies.

305: Anomaly detection in the selected space is performed on the dataset. That is, the selected anomaly detection method is used for analyzing the observations related to the target system.

Examples of anomaly detection methods that do not apply transformations include principal component analysis, isolation forest, and local outlier factor. Examples of anomaly detection methods that apply transformations include robust principal component analysis, kernel principal component analysis, and neural network-based methods. It is to be noted that embodiments of present disclosure do not require any changes in the details of the anomaly detection method.

306: Anomaly detection results from step 305 are provided for controlling the target system. That is, the anomaly detection results may be used for detecting problems in the target system and for taking respective corrective actions.

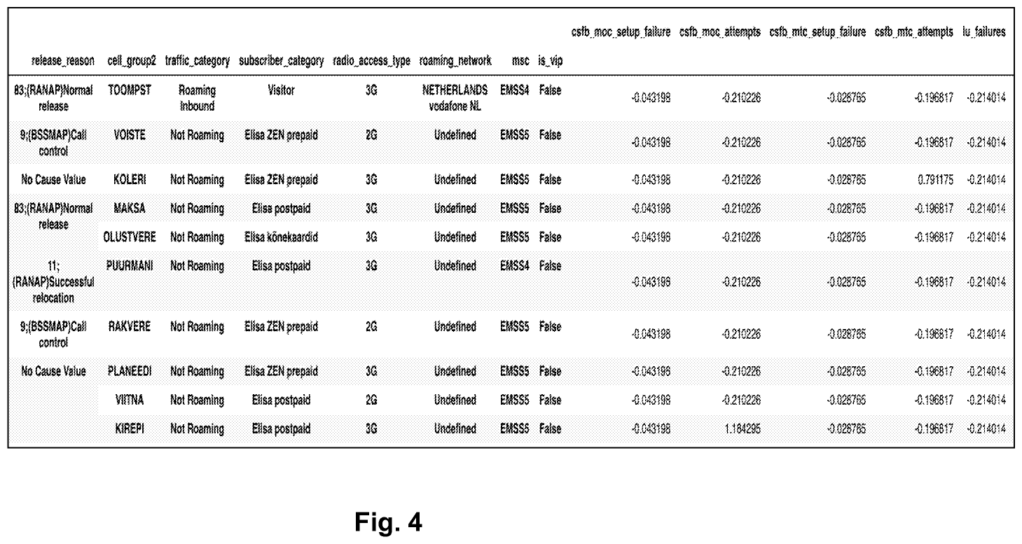

FIG. 4 shows dataset of an example case. The target system in this example is a mobile communication network and the dataset concerns performance counters of the mobile communications network. Additionally, the dataset includes dimension data identifying from where in the mobile communications network respective counter data is obtained. It is to be noted that FIG. 4 shows only part of the whole dataset.

The whole dataset of the example case contains 26942 rows and 27 columns (8 dimension columns and 19 counter columns). In an example, the non-linear alignment score for this dataset is computed using a radial kernel. The computation of linear alignment score ρₗᵢₙₑₐᵣ and radial alignment score ρ_{radial} results in ρₗᵢₙₑₐᵣ=0.141 and ρ_{radial}=0.846. Based on this it can be deduced that the anomalies in this dataset are best uncovered using methods that apply transformations such that the anomalies are sought by means of non-Euclidean measures. Examples of these include robust principal component analysis, kernel principal component analysis, and neural network-based methods.

Without in any way limiting the scope, interpretation, or application of the appended claims, a technical effect of one or more of the example embodiments disclosed herein is ability to automatically decide the set of anomaly detection methods that suit best the dataset that is to be analysed. In this way, a well-suited anomaly detection method can be automatically selected among different alternatives. Further, using an unlabelled dataset as a starting point is enabled.

A further technical effect is a new way of using kernel alignment calculations, namely using kernel alignment calculations for selecting which type of anomaly detection method to use.

A further technical effect is a new way to formulate the maximization of the kernel-target alignment score as an optimization problem with respect to the target vector. In this setting, the alignment score is maximized by a projected gradient algorithm. In this way, a new algorithm is provided for determining the alignment score.

Any of the afore described methods, method steps, or combinations thereof, may be controlled or performed using hardware; software; firmware; or any combination thereof. The software and/or hardware may be local; distributed; centralised; virtualised; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

The invention claimed is:

1. A computer implemented method for analyzing a target system for the purpose of controlling the target system, wherein the target system is a mobile communication network, an industrial process, a life science application, or an asset performance optimization system, the method comprising:
obtaining a dataset comprising observations related to the target system;
computing alignment score for the dataset using a linear kernel to obtain a linear alignment score;
computing alignment score for the dataset using a non-linear kernel to obtain a non-linear alignment score;
comparing the linear alignment score and the non-linear alignment score;
if linear alignment score>non-linear alignment score, selecting anomaly detection that uses Euclidean space measures, and else selecting anomaly detection that uses non-Euclidean space measures;
performing the selected anomaly detection on the dataset; and
providing results of the anomaly detection for detecting problems and taking corrective actions.

2. The method of claim 1, wherein the non-linear kernel is a radial kernel or a polynomial kernel.

3. The method of claim 1, wherein the dataset comprises unlabeled observations related to the target system.

4. The method of claim 1, wherein centered kernel target alignment method is applied for computing the alignment scores.

5. The method of claim 1, wherein the alignment scores are computed by maximizing alignment score relative to initially unknown label-vector.

6. The method of claim 5, wherein the maximization of the alignment score is formulated as an optimization problem with respect to a target vector.

7. The method of claim 6, wherein the maximization of the alignment score is performed using a process that iteratively updates the target vector until objective converges and that returns the target vector and the alignment score.

8. The method of claim 1, wherein non-Euclidean space measures comprise one or more of robust principal component analysis, kernel principal component analysis and neural network-based methods.

9. The method of claim 1, wherein Euclidean space measures comprise one or more of principal component analysis, isolation forest and local outlier factor.

10. The method of claim 1, wherein the target system is a mobile communication network, and the observations relate to network performance.

11. The method of claim 1, wherein the target system is an industrial process, and the observations comprise sensor data from the industrial process.

12. The method of claim 1, wherein the target system is a life science application, and the observations comprise measurement results.

13. An apparatus comprising:
a memory section comprising computer executable program code; and
a processing section configured to cause the apparatus to perform, when executing the program code, at least: the method of claim 1.

14. A non-transitory computer readable medium having stored there on a computer program comprising computer executable program code which when executed in an apparatus causes the apparatus to perform the method of claim 1.

15. The method of claim 2, wherein the dataset comprises unlabeled observations related to the target system.

16. The method of claim 2, wherein centered kernel target alignment method is applied for computing the alignment scores.

17. The method of claim 3, wherein centered kernel target alignment method is applied for computing the alignment scores.

18. The method of claim 2, wherein the alignment scores are computed by maximizing alignment score relative to initially unknown label-vector.

19. The method of claim 3, wherein the alignment scores are computed by maximizing alignment score relative to initially unknown label-vector.

20. The method of claim 4, wherein the alignment scores are computed by maximizing alignment score relative to initially unknown label-vector.
